(19) United States
(12) Patent Application Publication
(10) Pub. No.: US 2013/0310802 A1
(43) Pub. Date: Nov. 21, 2013

(54) Portable Insulated Carrier Containing Prepared Doses of Medications

(71) Applicant: Eileen C. Weinmann, Pittsburgh, PA (US)

(72) Inventor: Eileen C. Weinmann, Pittsburgh, PA (US)

(21) Appl. No.: 13/895,913

(22) Filed: May 16, 2013

Related U.S. Application Data
(60) Provisional application No. 61/647,621, filed on May 16, 2012.

(51) Int. Cl. A61J 1/10

(52) U.S. Cl. CPC A61J 1/10
USPC 604/506; 206/364; 224/600; 224/625; 220/592.2

(57) ABSTRACT

Provided herein is a portable insulated carrier for maintaining a syringe at an acceptable temperature for an extended period of time. The portable insulated carrier includes: a container having a front, a back, an open top, and defining an interior cavity; a closure for covering the open top of the container; at least one syringe holder in the interior cavity of the container, which is configured to receive and retain the syringe in an upright position; and an insulating member positioned in the insulating pocket, the insulating member being configured to prevent body heat of a user from being transferred to the syringe in the at least one syringe holder. The carrier is configured to maintain the syringe at a temperature of below 25 degrees Celsius for at least one hour.

### CROSS REFERENCE TO RELATED APPLICATION

This application claims the benefit of U.S. Provisional Patent Application No. 61/647,621 filed on May 16, 2012, on which priority of this patent application is based and which is hereby incorporated by reference in its entirety.

### BACKGROUND OF THE INVENTION

1. Field of the Invention

The present invention relates to an insulated carrier bag and, in particular, to an insulated carrier bag configured to hold syringes at controlled room temperature for an extended period of time.

2. Description of Related Art

During medical procedures, nurses, doctors, and other trained medical professionals are responsible for ensuring that medications needed for a particular procedure are readily accessible and can be quickly administered to the patient at the correct time. A nurse generally draws medication into a number of syringes prior to the start of the procedure. Often, the nurse must carry the syringes for extended periods of time before administering the syringe to the patient. However, nurses have numerous other responsibilities during the procedure. Therefore, holding the syringes the entire time is generally impossible, since the other responsibilities require that the nurse have unrestricted use of his or her hands. Placing the syringes containing medication on a tray or cart is also often impractical due to sterility or space concerns. Accordingly, nurses, medical technicians, and similar medical professionals must find ways to carry syringes and other medication devices during procedures so that the medications are available when needed.

In some circumstances, the nurse may use a fanny pack or simply place the syringe in his or her pocket. However, medications carried this way are likely to be exposed to the carrier's body heat, thereby increasing the temperature of the medication contained in the syringe. Specifically, when the object is held against a user's body, the possibility of heat transfer from the user to the medication is increased. The chemical composition of some pharmacological agents changes as temperature increases. Therefore, according to generally accepted pharmaceutical standards, many medications should be maintained at “controlled room temperature.” Controlled room temperature is defined as the temperature of a typical working environment, generally about 20 to 25 degrees Celsius. Medications tend to degrade or become ineffective if exposed to temperatures in excess of controlled room temperature for extended periods of time.

To prevent medications in prepared syringes from spoiling during a procedure, medical facilities have installed refrigeration units in operating rooms and surgical suites. These refrigeration units ensure that prefilled syringes are maintained within strict temperature limits until they are administered to a patient. However, these units are expensive and, to ensure that medications are accessible when needed, generally must be installed in each room, meaning that a single medical facility must install many units. Furthermore, even when syringes are placed in a refrigeration unit in an operating room, a nurse still must take the time to access the refrigeration unit to obtain the syringe before administering it to a patient. The nurse is not able to carry the syringe on his or her person. Accordingly, rather than taking the time to access a refrigeration unit each time a new syringe is needed, nurses may still hold multiple syringes or carry them in their pockets. Therefore, the risk that medication will spoil due to prolonged exposure to body heat is present even when refrigeration units are available.

In view of the deficiencies in current apparatus and methods for maintaining prepared syringes, there is a need for a carrying device for medications used during surgery and other medical procedures. The carrier should not restrict the movement of the user and should allow for easy access to and removal of the medication from the carrier at the appropriate time. Furthermore, the carrier should be maintained in a position far enough away from the body of the user that heat transfer between the user and medication is negated. It is further noted that nurses are often responsible for preparing and keeping track of drugs that are controlled substances. Accordingly, there is a need for a carrying device which allows the nurse to keep the medication on his or her person at all times. The nurse should have constant awareness of the location and condition of the controlled substances while still being able to perform other job functions.

### SUMMARY OF THE INVENTION

A portable insulated carrier is disclosed herein which overcomes the deficiencies of previously used methods and apparatus for maintaining a therapeutic agent prior to administering the agent to a patient. The carrier is configured to protect syringes containing therapeutic agents from the body heat of a user. Specifically, the carrier maintains the therapeutic agent at a controlled temperature of below 25 degrees Celsius. In addition, the carrier ensures that medications are easily accessible, so that they can be administered to a patient in a timely fashion.

In accordance with one aspect of the invention, a portable insulated carrier for a syringe includes: a container having a front, a back, an open top, and defining an interior cavity; a closure for covering the open top of the container; at least one syringe holder in the interior cavity of the container, which is configured to receive and retain a syringe in an upright position; and an insulating member positioned in the insulating pocket, the insulating member being configured to prevent body heat of a user from being transferred to the syringe. The carrier is configured to maintain the syringe at a temperature of below 25 degrees Celsius for at least one hour.

In accordance with a second aspect of the invention, a portable insulated carrier includes: a container having a front, a back, an open top, and defining an interior cavity; a closure, which in a closed position, covers the open top of the container; at least one cylindrical holder in the interior cavity of the container, wherein the at least one cylindrical holder is configured to receive and retain an object in an upright position; and an insulating member located at least between the back of the container and the at least one cylindrical holder for preventing body heat of a user from being transferred to the object contained within the cylindrical holder. The carrier is configured to maintain the object at a temperature of below 25 degrees Celsius for at least one hour.

In accordance with a third aspect of the invention, a method for holding a syringe containing a prepared dose of a therapeutic agent is provided. The method includes the steps of drawing a therapeutic agent into one or more disposable syringes; placing the one or more syringes in at least one syringe holder of a portable insulated carrier; removing one or more of the syringes from the carrier for administering the medication contained therein to a patient; and disposing of the syringe after the injection is completed. The insulated carrier includes: a container having a front, a back, an open top, and defining an interior cavity; a closure for covering the open top of the container; the at least one syringe holder; an insulating pocket accessible through a slot extending longitudinally across the container and positioned between the at least one syringe holder and the back of the container; and an insulating member positioned in the insulating pocket, the insulating member being configured to prevent body heat of a user from being transferred to the syringe. The carrier is configured to maintain the syringe at a temperature of less than 25 degrees Celsius for at least one hour.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

For the purpose of facilitating understanding of the invention, the accompanying drawings and description illustrate preferred embodiments thereof, from which the invention, various embodiments of its structures, construction and method of operation, and many advantages may be understood and appreciated.

FIG. 1 is a front view of a portable insulated carrier in the closed position embodying various features of the present invention;

FIG. 2 is a rear view of the carrier of FIG. 1 in the closed position;

FIG. 3 is a front view of the carrier of FIG. 1 in the open position;

FIG. 4 is a top view of the carrier of FIG. 1 in the open position; and

FIG. 5 is a top view of a portable insulated carrier in the open position according to a further embodiment of the present invention.

### DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

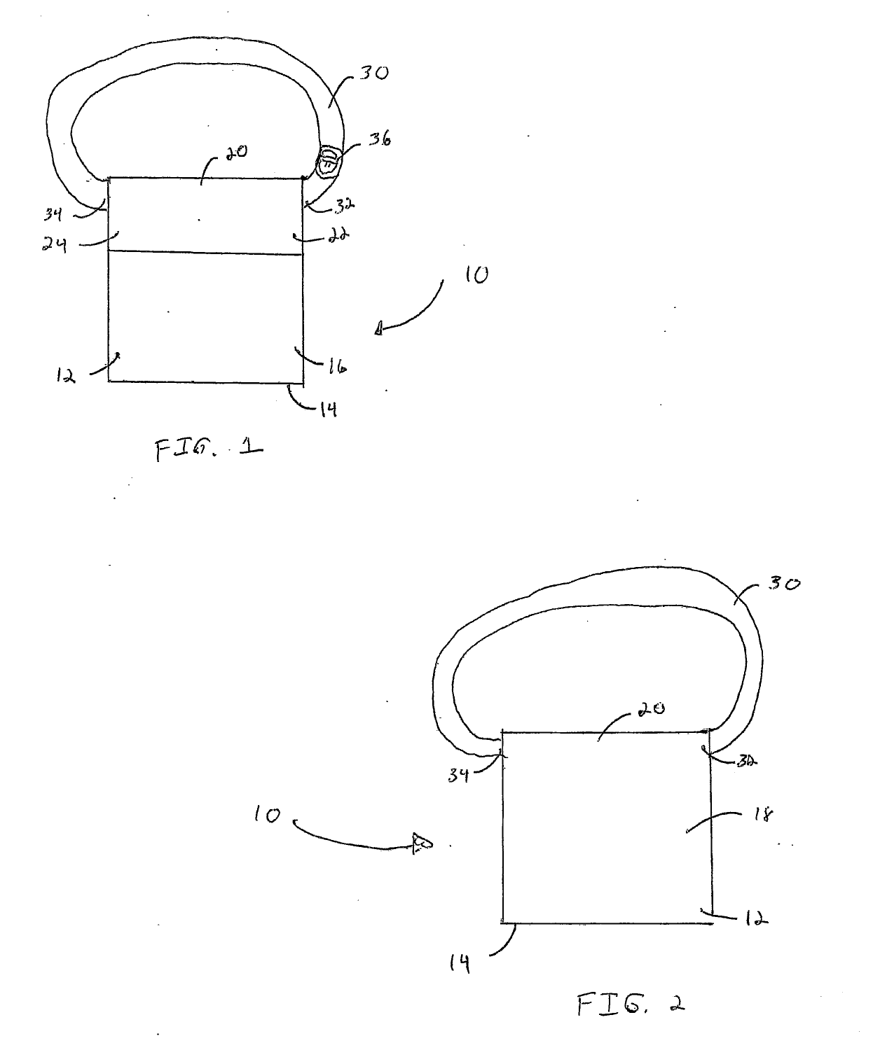

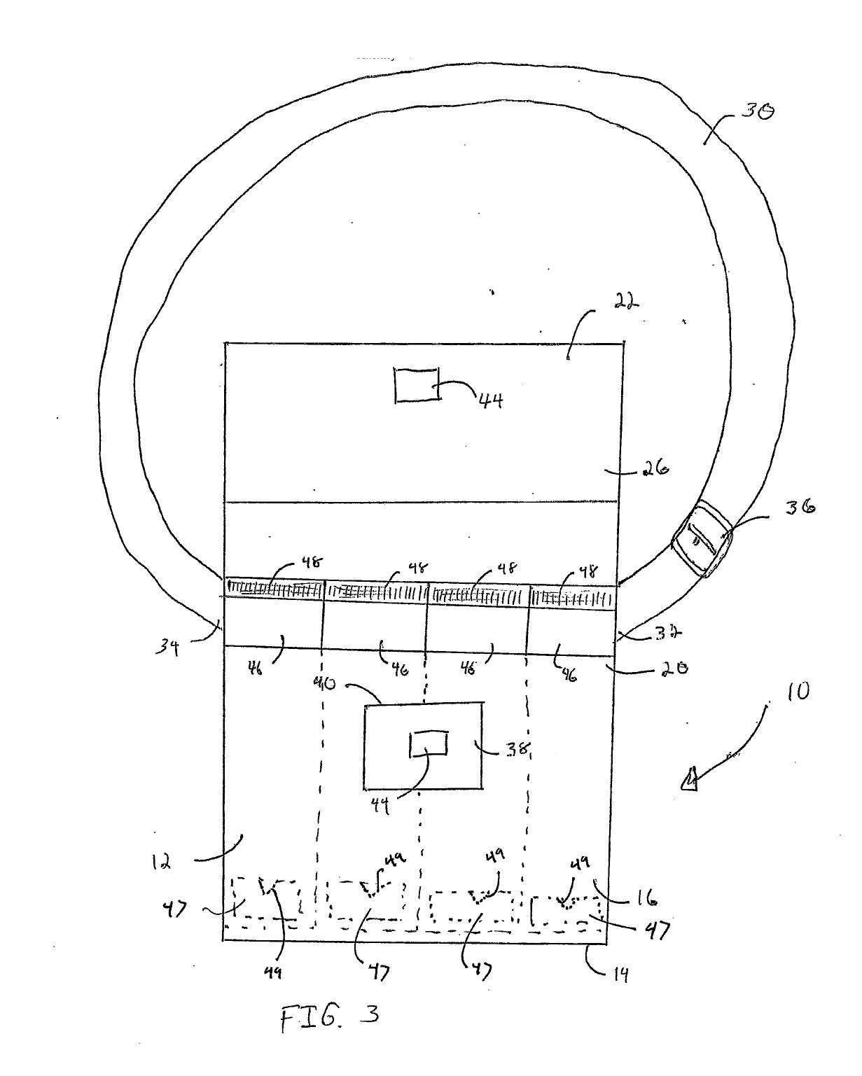

As depicted in FIGS. 1-4, a non-limiting embodiment of a portable insulated carrier 10 for medications, according to the present invention, is provided. With reference to FIGS. 1 and 2, the portable carrier 10 includes a container 12 having a bottom 14, a front face 16, a rear face 18, and a top opening 20. The container 12 can be made of a water resistant fabric which is easy to clean after use. Since medications may be affected by exposure to light, the fabric must also be impervious to light. In one embodiment, the container 12 is constructed from a fabric known as “oil cloth.” Oil cloth consists of about 91% polyvinyl chloride (PVC), 6% polyester, and 3% cotton. Alternatively, the container 12 may be formed from blackboard fabric consisting of 90% PVC, 6% polyester, and 3% cotton or of Marine Vinyl fabric consisting of 100% PVC. Ideally, the fabric should be waterproof, easily wiped clean, and structurally strong enough to hold its shape without collapsing.

In a closed position, as depicted in FIGS. 1 and 2, a closure flap 22 having a front 24 and a back 26 extends over the top opening 20 of the container 12. Alternatively, the top opening 20 of the container 12 may be closed and held together by other means such as a zipper or clasping mechanism for bringing together and maintaining a connection between the front face 16 and rear face 18 of the container 12.

With continued reference to FIGS. 1 and 2, the carrier 10 further includes a strap 30 for carrying the carrier 10 over a user's shoulder, having a first end 32 and a second end 34. The first end 32 and the second end 34 are connected to the container 12 near the top opening 20. The strap 30 may be a fixed length or may be adjusted through, by example, a buckle 36 attached to the strap 30. The strap may be made of any sufficiently strong and lightweight material, such as nylon webbing. In another non-limiting and preferred embodiment, the strap is configured to fit around the waist of a user, for holding the carrier 10 against the user's waist.

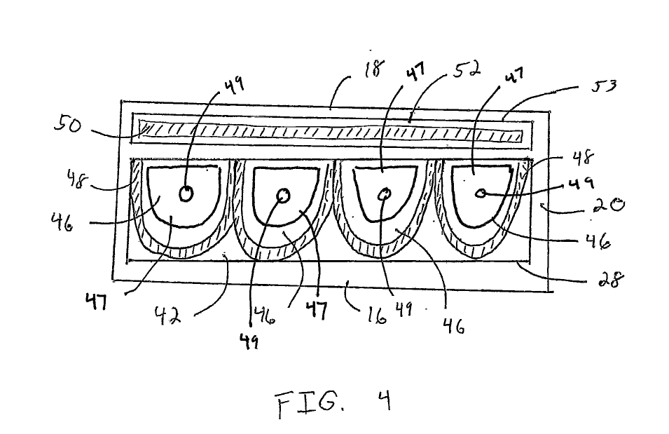

With reference now to FIG. 3, the flap 22 is depicted in the open position revealing an interior cavity 42. Corresponding sections of a fastener 44 are positioned on the underside of the closure flap 22 and on the front face 16 of the container 12. In the closed position, the corresponding sections of the fastener 44 come into holding engagement to hold the flap 22 in place and to prevent objects contained within the interior cavity 42 of the carrier 10 from falling out. In one non-limiting embodiment, the fastener 44 is made from Velcro® or a similar non-metallic releasable adhesive fabric. When the fastener 44 is non-metallic, the portable carrier 10 is safe for use in close proximity to an MRI machine. Alternatively, the fastener 44 could be a magnetic clasp, zipper, button, or other clasping device as are known in the art.

With continued reference to FIG. 3, the carrier 10 further includes one or more exterior pockets 38. According to one non-limiting embodiment of the invention, the exterior pocket 38 is located on front face 16 of the container 12. In the closed position, the flap 22 extends over an opening 40 of the exterior pocket 38 to prevent items contained within the pocket 38 from falling out. Alternatively, the pocket 38 may be located on the rear face 18 of the container 12, on the flap 22, or in any other convenient and accessible location. The pocket 38 is used for carrying medical supplies including, but not limited to, alcohol wipes, syringe caps, and labels for medications.

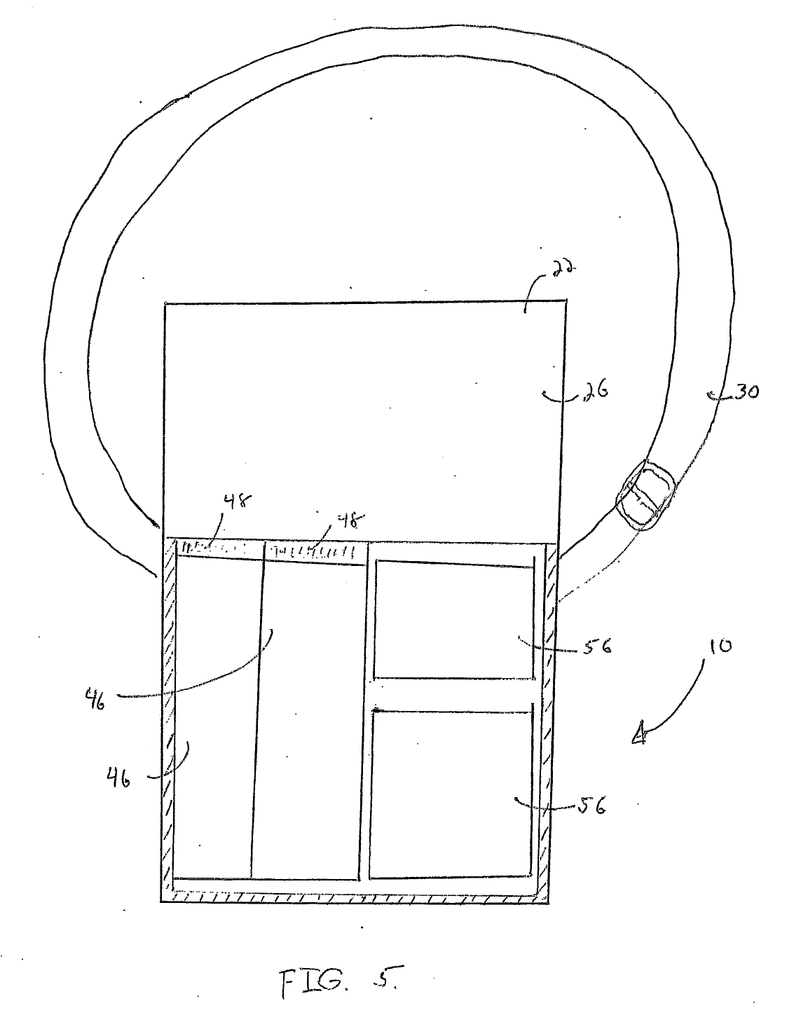

With reference now to FIG. 4, a plurality of syringe holders 46 are located within the interior cavity 42 of the container 12. The holders 46 extend from the top opening 20 to the bottom 14 of the container 12. Each syringe holder 46 includes a straight wall and a curved wall and defines a semi-cylindrical cavity adapted to receive one or more syringes. According to one non-limiting embodiment, a mesh support 48 is placed within the holder 46 and maintains the semi-cylindrical shape of the cavity. The support 48 may be formed from a vinyl sheet or other flexible material, which is strong enough to maintain the shape of the holder 46. As shown in the figures, one non-limiting embodiment includes four holders 46 arranged in linear configuration. In a preferred and non-limiting embodiment, each holder 46 is about 3 cm to 5 cm in diameter, which is large enough to hold two 10 cc syringes. However, it is understood that the holders 46 may be different sizes to accommodate different sized syringes. As long as the syringe holders 46 are not labeled as containing a specific type of medication, there is no conflict in placing multiple syringes containing different medications in a single syringe holder 46. However, each syringe should be individually labeled.

With continued reference to FIG. 4, a tip guard 47 may be placed in a bottom portion of each syringe holder 46. The tip guard may be a semi-circular piece of foam or plastic adapted to prevent the tip of a needle from contacting the walls of the container 12. The tip guard also serves as an insulating material for protecting the syringes from a user's body heat. Finally, the tip guard 47 could be configured to help maintain the syringe in an upright position. For example, the tip guard 47 may include an indentation 49. The tip or tip cover of the syringe could be inserted in the indentation 49.

With continued reference to FIG. 4, the carrier 10 further includes an insulating member 50 situated between the plurality of syringe holders 46 and the rear face 18 of the container 12. According to one embodiment of the invention, an insulation pocket 52 is formed between the holders 46 and the interior surface of the rear face 18. The insulation pocket 52 may be accessible through a longitudinal slot 53 extending parallel to the rear face 18 of the container 12. A rectangular shaped piece of insulation material 50 is adapted to be placed within the pocket 52. The insulating material 50 should be sufficient to maintain separation between the body of a user and the medication containing syringes. Ideally, the insulation material 50 should be sufficient to maintain the medications at controlled room temperature and to avoid the transfer of body heat from the user to the medications. According to one embodiment of the invented carrier 10, the insulating material 50 is foam having a width of about 2 mm. Alternatively, materials having cooling or heat shielding properties could also be used within the scope of the present invention.

With reference to FIG. 5, a further embodiment of the carrier 10 is depicted. In this embodiment, the carrier 10 contains a reduced number of syringe holders 46. For example, the embodiment of FIG. 5 includes only two syringe holders 46. The carrier 10 further includes interior pockets 56 positioned near the syringe holders 46 in the interior of the container 12. As shown in FIG. 5, the carrier 10 includes two pockets oriented vertically with a first pocket located above the second pocket. It is understood, however, that within the scope of the invention, pockets 56 may be provided in numerous other configurations including being aligned horizontally or with interior pockets 56 located between the syringe holders 46. The interior pockets 56 may be different sizes. The interior pockets 56 are used to hold larger medical supplies that do not fit in the exterior exterior pocket 38. For example, medication vials, such as a vial of propofol, may be carried in interior pocket 56.

In one non-limiting embodiment of the present invention, the carrier 10 is configured for use by a sedation nurse. In use, the nurse selects medications that are needed for sedating a single patient. Medications that may be injected with a syringe by a sedation nurse, and which the nurse would commonly carry in the carrier 10 include, but are not limited to, Versed, Fentanyl, Pentobarbital, Ketamine, atropine, and Zofran. The carrier 10 may also be used to carry additional medications including antibiotics, valium tablets, liquid Versed and liquid valium. Glucagon, for use in an MRI may also be carried using the carrier 10. One of the syringes may also contain saline solution. The syringes may come with labels already affixed with information including the medication, concentration, dose volume, and the patient's name. Alternatively, the nurses may prepare labels themselves and place them on the syringes.

The nurse prepares the medications for injection by drawing selected medications into syringes. Specifically, a needle is placed on the syringe and the user draws the medication from a vial into the syringe. After the medication is drawn from the vial, the needle is removed from the syringe and discarded. A syringe cap, namely a small blunt plastic cover, is then placed over the tip of the syringe. The cap effectively covers the tip to keep it clean and to prevent premature release of medication. The nurse places the capped syringes in the syringe holders 46 of the carrier 10 and closes the carrier 10 by placing the flap 22 over the top opening 20 of the container 12. The flap 22 is secured in the closed position with the fasteners 44. To prevent accidently providing the wrong medication to a patient, it is understood that all medications held in one carrier 10 should be intended for administration to a single patient. It is further understood that the nurse may need to draw the medications 40-50 minutes or more before administering them to a patient. During the procedure, the user opens the carrier 10 and removes the appropriate syringe at the appropriate time. Once the medication contained within the syringe is administered to the patient, the syringe is disposed of in an appropriate and medically sanitary fashion. Used syringes are not placed in the carrier 10. Following use, the carrier 10 can be cleaned with an antibacterial wipe or similar cleaning method.

As described above, the nurse will typically administers the drugs to a patient within an hour after preparing the syringe. However, tests of carriers 10 of the construction described above indicate that medications held in the carrier 10 may be maintained at a temperature of between 23 and 24 degrees Celsius for between 8 and 9 hours. Accordingly, it is understood that the carrier 10 of the present invention may also be used to carry medications for a single patient for a care provider's entire shift. It is noted, however, that, according to manufacturer's instructions, prepared syringes containing a reconstituted medication cannot be used more than one hour after reconstitution to maintain the integrity of the reconstituted fluid.

For example, in a second embodiment of the present invention, the carrier 10 is adapted for use in a homecare setting. In this instance, the carrier 10 contains syringes with medications that the individual patient uses on a daily basis. In use, a home care provider enters the house and goes to the location, usually the patient's bedroom, where medications are stored. The user prepares the medication containing syringes according to the process described above and places the syringes in the carrier 10. The user wears the bag around the house using the strap 30 and administers medication to the patient as needed. At the end of the user's shift, the user removes the carrier 10 and leaves it at the house for use by the home care provider working the next shift. When the next home care provider arrives, he or she prepares additional medications, as necessary, and wears the carrier 10 for the duration of the shift. Notably, the carrier 10 remains with the patient and contains only medications for that particular patient. Alternatively, the carrier 10 may be used by a care giver when the home care patient leaves the house. For example, many children attend school or play outdoors. The caregiver could place the day's medications in the carrier 10 and take the medications with them. Beneficially, the carrier 10 would keep medications safe and clean while the patient is away from home.

According to a further non-limiting embodiment of the present invention, the carrier 10 is modified for use to carry supplies for a baby or small child. In this embodiment, the syringe holders 46 are enlarged to hold items needed while caring for a baby or small child such as a bottle, toys, crayons, etc. The insulation properties of carrier 10 prevent baby formula contained in a bottle from becoming too warm for consumption. Similarly, the exterior pocket 38 is enlarged to hold supplies including, but not limited to, pacifiers, baby wipes, or a diaper pack.

While specific embodiments of the carrier and method of use thereof have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof. Further, although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A portable insulated carrier for a syringe comprising:
a container having a front, a back, an open top, and defining an interior cavity;
a closure for covering the open top of the container;
at least one syringe holder in the interior cavity of the container, which is configured to receive and retain the syringe in an upright position;
an insulating pocket accessible through a slot extending longitudinally across the container and positioned between the at least one syringe holder and the back of the container; and
an insulating member positioned in the insulating pocket, the insulating member being configured to prevent body heat of a user from being transferred to the syringe in the at least one syringe holder,
wherein the carrier is configured to maintain the syringe at a temperature of less than 25 degrees Celsius for at least one hour.

2. The portable insulated carrier of claim 1, wherein the container is formed from a flexible and water-resistant fabric which is impervious to light.

3. The portable insulated carrier of claim 1, further comprising a strap attached to the container and configured to be worn over the shoulder of a user.

4. The portable insulated carrier of claim 3, wherein the strap comprises a buckle for adjusting the length of the strap.

5. The portable insulated carrier of claim 3, wherein the strap is configured to be worn around the waist of a user.

6. The portable insulated carrier of claim 1, wherein the closure comprises a flap affixed to the back of the carrier, and which is configured to fold over the open top of the carrier.

7. The portable insulated carrier of claim 6, wherein the flap further comprises a fastener configured to engage a corresponding fastener located on the front of the insulated carrier, to maintain the flap in a closed position.

8. The portable insulated carrier of claim 7, further comprising an exterior pocket on the front of the carrier, positioned such that the flap covers the exterior pocket, when the flap is in the closed position.

9. The portable insulated carrier of claim 1, wherein the at least one syringe holder has a semi-circular cross section and comprises a straight wall and a curved wall, the straight wall being in contact with the insulating pocket.

10. The portable insulated carrier of claim 9, wherein the at least one syringe holder is configured to hold a 10 cc syringe.

11. The portable insulated carrier of claim 10, wherein the at least one syringe holder has a cross section diameter of between about 3 cm and 5 cm.

12. The portable insulated carrier of claim 9, wherein the carrier comprises at least two syringe holders positioned longitudinally in the interior cavity, such that the straight wall of each of the syringe holders is in contact with the insulating pocket.

13. The portable insulated carrier of claim 9, wherein the at least one syringe holder comprises a support member for maintaining the shape of the curved wall of the syringe holder.

14. The portable insulated carrier of claim 13, wherein the support member is a plastic mesh sheet inserted in the at least one syringe holder.

15. The portable carrier of claim 1, wherein the insulating member comprises a foam sheet with a thickness of about 2.0 mm.

16. The portable insulated carrier of claim 1, wherein the at least one syringe holder further comprises a tip guard positioned at the bottom of the syringe holder for preventing the syringe from contacting a bottom interior portion of the container.

17. The portable insulated carrier of claim 1 further comprising at least one vial pocket in the interior cavity of the container for holding a medical vial.

18. The portable insulated carrier of claim 17, wherein the at least one vial pocket is in contact with the insulating pocket to protect the medical vial from being exposed to body heat of a user.

19. A portable insulated carrier comprising:
a container having a front, a back, an open top, and defining an interior cavity;
a closure, which in a closed positioned, covers the open top of the container;
at least one cylindrical holder in the interior cavity of the container, wherein the at least one cylindrical holder is configured to receive and retain an object in an upright position; and
an insulating material located at least between the back of the container and the at least one cylindrical holder for preventing body heat of a user from being transferred to the object contained within the cylindrical holder,
wherein the carrier is configured to maintain the object at a temperature of less than 25 degrees Celsius for at least one hour.

20. A method for holding a syringe containing a prepared dose of a therapeutic agent comprising:
drawing a therapeutic agent into one or more disposable syringes;
placing the one or more syringes in at least one syringe holder of a portable insulated carrier, the carrier comprising
a container having a front, a back, an open top, and defining an interior cavity,
a closure for covering the open top of the container,
the at least one syringe holder,
an insulating pocket accessible through a slot extending longitudinally across the container and positioned between the at least one syringe holder and the back of the container, and
an insulating member positioned in the insulating pocket, the insulating member being configured to prevent body heat of a user from being transferred to the syringe in the at least one syringe holder, wherein the carrier is configured to maintain the syringe at a temperature of less than 25 degrees Celsius for at least one hour;
removing one or more of the syringes from the carrier for administering the medication contained therein to a patient; and
disposing of the syringe after the injection is completed.
